(19) United States
(12) Patent Application Publication
(10) Pub. No.: US 2021/0218006 A1
(43) Pub. Date: Jul. 15, 2021

(54) ELECTRODE ASSEMBLY AND METHOD OF MAKING THE SAME

(71) Applicant: GM GLOBAL TECHNOLOGY OPERATIONS LLC, Detroit, MI (US)

(72) Inventors: Jing Gao, Rochester, MI (US); Brian J. Koch, Berkley, MI (US); Zhe Li, Rochester, MI (US); Yucong Wang, West Bloomfield, MI (US)

(21) Appl. No.: 16/740,018

(22) Filed: Jan. 10, 2020

(51) Int. Cl. H01M 2/26

(52) U.S. Cl. CPC H01M 2/26

(57) ABSTRACT

Disclosed is an electrode assembly, comprising: an electrode; and an electrode tab, wherein the electrode tab is attached to the electrode, wherein the electrode tab comprises: a center portion, wherein the center portion comprises an attachment mechanism, wherein the electrode tab is attached to the electrode via the attachment mechanism; a protrusion portion, wherein the protrusion portion extends from the center portion and protrudes beyond a perimeter of the electrode; and a rounded portion, wherein the rounded portion extends from the center portion in a direction opposite the protrusion portion.

### INTRODUCTION

The subject disclosure relates to the art of electrode assemblies, and more particularly, to electrode tabs for flexible reference electrodes.

Battery cells, such as pouch cells, include electrode assemblies. For example, an electrode assembly includes an electrode tab attached to an electrode. The electrode tab functions to conduct electricity to and/or from the electrode. Electrode tabs are attached to their respective electrodes using a mechanical fastening means, for example, welding. However, in the case of flexible electrodes, the electrode can lack the mechanical integrity to support a mechanical fastening means of attachment.

Accordingly, it is desirable to provide an electrode assembly which includes a flexible electrode and an electrode tab which is compatible with the flexible electrode, both in terms of electrical conductivity and its mechanical properties.

### SUMMARY

In one exemplary embodiment, an electrode assembly comprises an electrode and an electrode tab, wherein the electrode tab is attached to the electrode. The electrode tab comprises a center portion, wherein the center portion comprises an attachment mechanism. The electrode tab is attached to the electrode via the attachment mechanism. The electrode tab comprises a protrusion portion, wherein the protrusion portion extends from the center portion and protrudes beyond a perimeter of the electrode. The electrode tab comprises a rounded portion, wherein the rounded portion extends from the center portion in a direction opposite the protrusion portion.

In addition to one or more of the features described herein, the attachment mechanism comprises a textured surface and an adhesion layer deposited on the textured surface, wherein the electrode tab is attached to the electrode via the adhesion layer.

In addition to one or more of the features described herein, the electrode is a reference electrode.

In addition to one or more of the features described herein, the reference electrode is flexible.

In addition to one or more of the features described herein, the electrode tab comprises metal, carbon, polymer, or any combination(s) thereof.

In addition to one or more of the features described herein, the electrode tab comprises gold, aluminum, carbon mesh, carbon cloth, a polymer plated with metal, or any combination(s) thereof.

In addition to one or more of the features described herein, the protrusion portion of the electrode tab is polygonal in shape, circular in shape, or any combination(s) thereof.

In addition to one or more of the features described herein, the protrusion portion of the electrode tab is “T” shaped.

In addition to one or more of the features described herein, the protrusion portion of the electrode tab protrudes beyond the perimeter of the electrode by a length of about 1 millimeter to about 5 millimeters.

In addition to one or more of the features described herein, the textured surface of the center portion has an average surface roughness value (Ra) of greater than or equal to about 2 micrometers.

In addition to one or more of the features described herein, the textured surface of the center portion has a developed surface area ratio of greater than or equal to about 40%.

In addition to one or more of the features described herein, the adhesion layer of the center portion comprises an electrically conductive adhesive material.

In addition to one or more of the features described herein, the electrically conductive adhesive material comprises an epoxy base, an acrylate base, a silicone base, or any combination(s) thereof, and a filler material.

In addition to one or more of the features described herein, the filler material comprises steel, gold, nickel, silver, copper, graphite, or any combination(s) thereof.

In addition to one or more of the features described herein, an electrical conductivity of the electrode tab is greater than or equal to about 2000 Siemens per centimeter.

In addition to one or more of the features described herein, masking material is deposited on a surface of the protrusion portion of the electrode tab, the rounded portion of the electrode tab, or any combination(s) thereof.

In addition to one or more of the features described herein, the electrode tab is free of bolts, screws, nails, clamps, or any combination(s) thereof.

In another exemplary embodiment, a battery cell comprises an electrode assembly, wherein the electrode assembly comprises an electrode and an electrode tab, wherein the electrode tab is attached to the electrode. The electrode tab comprises a center portion, wherein the center portion comprises a textured surface, and an adhesion layer deposited on the textured surface, wherein the electrode tab is attached to the electrode via the adhesion layer. The electrode tab comprises a protrusion portion, wherein the protrusion portion extends from the center portion and protrudes beyond a perimeter of the electrode. The electrode tab comprises a rounded portion, wherein the rounded portion extends from the center portion in a direction opposite the protrusion portion. The battery cell is a three-electrode pouch cell.

In yet another exemplary embodiment, an electrode assembly comprises an electrode and an electrode tab, wherein the electrode tab is attached to the electrode. The electrode tab comprises a center portion, wherein the center portion comprises a textured surface, and an adhesion layer deposited on the textured surface, wherein the electrode tab is attached to the electrode via the adhesion layer. The electrode tab comprises a protrusion portion, wherein the protrusion portion extends from the center portion and protrudes beyond a perimeter of the electrode. The electrode tab comprises a rounded portion, wherein the rounded portion extends from the center portion in a direction opposite the protrusion portion. A method of making the electrode assembly comprises roughing a surface of the center portion of the electrode tab to form the textured surface and cleaning the textured surface of debris. The method further comprises depositing an electrically conductive adhesive material to the textured surface to form the adhesion layer. The method further comprises applying a masking material to a surface of the protrusion portion of the electrode tab, the rounded portion of the electrode tab, or any combination(s) thereof and attaching the electrode tab to the electrode via the adhesion layer.

In addition to one or more of the features described herein, roughing the surface of the center portion of the tab comprises chemical etching, abrasion by an abrasive material, abrasion by ultrasonic waves, blasting with an abrasive material, or any combination(s) thereof.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side-view (Z-direction) of an electrode assembly according to an exemplary embodiment;

FIG. 2 is a front-view (Y-direction) of an electrode assembly according to an exemplary embodiment;

FIG. 3 is a battery according to an exemplary embodiment; and

FIG. 4 is a flow diagram representing a method of making an electrode assembly according to an exemplary embodiment.

### DETAILED DESCRIPTION

The following description is merely exemplary in nature and is not intended to limit the present disclosure, its application or uses.

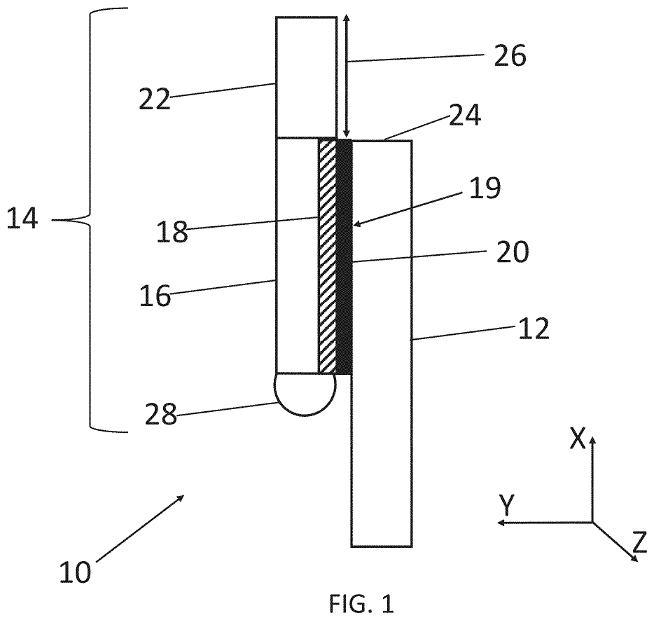

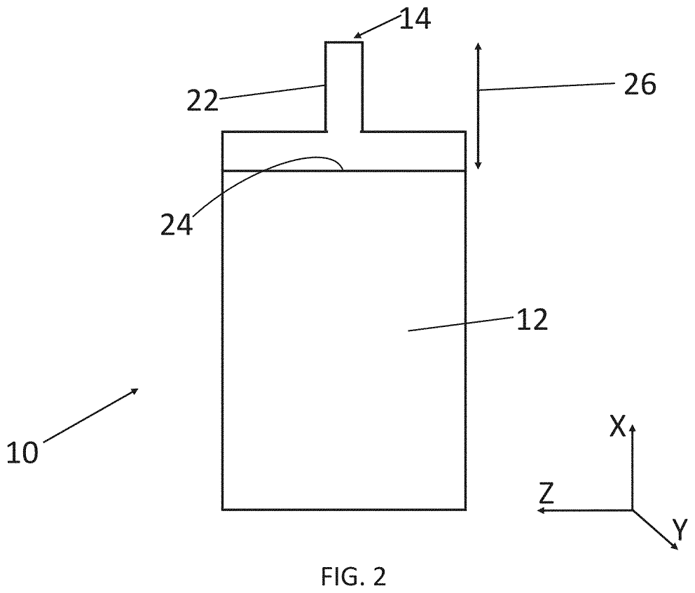

In accordance with an exemplary embodiment, as shown in FIG. 1 and FIG. 2, an electrode assembly 10 comprises an electrode 12 and an electrode tab 14. The electrode tab 14 comprises a center portion 16, wherein the center portion 16 comprises an attachment mechanism 19. The electrode tab 14 is attached to the electrode 12 via the attachment mechanism 19. The electrode tab 14 further comprises a protrusion portion 22, wherein the protrusion portion 22 extends from the center portion 16 and protrudes beyond a perimeter 24 of the electrode 12. The electrode tab 14 further comprises a rounded portion 28, wherein the rounded portion 28 extends from the center portion 16 in a direction opposite the protrusion portion 22.

According to an embodiment, the attachment mechanism 19 can comprise a textured surface 18, and an adhesion layer 20 deposited on the textured surface 18. The electrode tab 14 is attached to the electrode 12 via the adhesion layer 20. In addition, or alternatively, the attachment mechanism can comprise any other suitable mechanism for attachment to an electrode, for example, a mechanical fastening means, for example, a bolt, a screw, a nail, a clamp, or any combination(s) thereof.

According to an embodiment, the electrode 12 can be a cathode, anode, reference electrode, or any combination(s) thereof. For example, the electrode 12 can be a reference electrode, wherein the reference electrode is flexible. The electrode 12 can be any suitable shape and/or size for battery use. For example, the electrode 12 can be polygonal, for example, rectangular. According to an embodiment, the electrode 12 can taper in width (i.e., decrease in width from one end to another).

According to an embodiment, the electrode tab 14 can comprise metal, carbon, polymer, or any combination(s) thereof. For example, the electrode tab 14 can comprise gold, aluminum, carbon mesh, carbon cloth, a polymer plated with metal, or any combination(s) thereof.

According to an embodiment, the protrusion portion 22 of the electrode tab 14 can be polygonal in shape, circular in shape, or any combination(s) thereof. For example, the protrusion portion 22 of the electrode tab 14 can be “T” shaped (as shown in FIG. 2 when viewed from the Y-direction). The protrusion portion 22 of the electrode tab 14 can protrude beyond the perimeter 24 of the electrode 12 by a length 26 of about 0.1 millimeters to about 20 millimeters, for example, about 0.5 millimeter to about 10 millimeters, for example, about 1 millimeters to about 5 millimeters. The protrusion portion 22 of the electrode tab 14 can protrude beyond the perimeter 24 of the electrode 12 by a length 26 of greater than or equal to about 1 millimeter, for example, greater than or equal to about 5 millimeters, for example, greater than or equal to about 10 millimeters.

According to an embodiment, the textured surface 18 of the center portion 16 can have an average surface roughness value (Ra) of greater than or equal to about 1 micrometer, for example, greater than or equal to about 2 micrometers, for example, greater than or equal to about 5 micrometers, for example, greater than or equal to about 10 micrometers. The textured surface 18 of the center portion 16 can have an average surface roughness value (Ra) of about 1 micrometer to about 10 micrometers, for example, about 2 micrometers to about 5 micrometers. The average surface roughness value (Ra) can be measured by any suitable method, for example, a method in accordance with ISO 4287:1997.

According to an embodiment, the textured surface 18 of the center portion 16 can have a developed surface area ratio of greater than or equal to about 30%, for example, greater than or equal to about 40%, for example, greater than or equal to about 50%, for example, greater than or equal to about 60%. The developed surface area ratio can be expressed as the percentage of an area's additional surface area contributed by the texture as compared to a completely level surface (i.e., 0%). The developed surface area ratio can be measured by any suitable method, for example, a method in accordance with ISO 4287:1997.

According to an embodiment, the adhesion layer 20 of the center portion 16 can comprise an electrically conductive adhesive material. For example, the electrically conductive adhesive material can comprise an epoxy base, an acrylate base, a silicone base, or any combination(s) thereof. The electrically conductive adhesive material can comprise a filler material. For example, the filler material can comprise steel, gold, nickel, silver, copper, graphite, or any combination(s) thereof. The electrode tab 14 can be attached to the electrode 12 via the adhesion layer 20. In this way, the electrode tab 14 can avoid the use of mechanical fastening means when being attached to the electrode 12. For example, the electrode tab 14 can avoid the use of a bolt and/or screw fastening means.

According to an embodiment, an electrical conductivity of the electrode tab 14 can be greater than or equal to about 1000 Siemens per centimeter, for example, greater than or equal to about 2000 Siemens per centimeter, for example, greater than or equal to about 5000 Siemens per centimeter, for example, greater than or equal to about 10,000 Siemens per centimeter. The electrical conductivity of the electrode tab 14 can be about 1000 Siemens per centimeter to about 10,000 Siemens per centimeter, for example, about 2000 Siemens per centimeter to about 5,000 Siemens per centimeter. The electrical conductivity can be measured by any suitable method, for example, a method in accordance with ISO 9944:1990.

According to an embodiment, the electrode tab 14 can further comprise a layer of masking material. The masking material can prevent adhesion in locations where adhesion is not desired. For example, the masking material can be deposited on a surface of the protrusion portion 22 of the electrode tab 14, the rounded portion 28 of the electrode tab 14, or any combination(s) thereof. The masking material can be any material suitable for preventing adhesion, for example, masking tape.

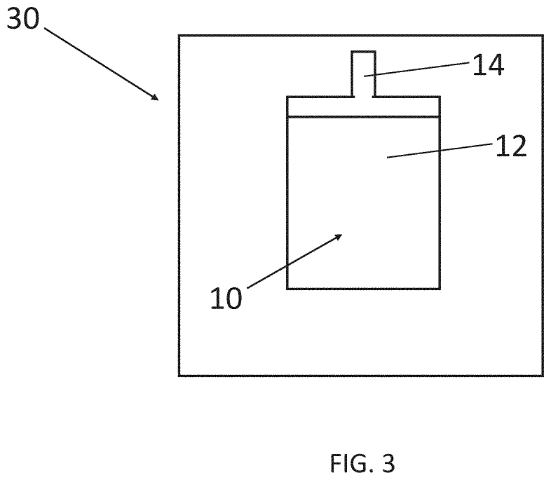

Now referring to FIG. 3, in accordance with an exemplary embodiment, a battery cell 30 comprises an electrode assembly 10. The electrode assembly 10 can comprise an electrode 12 and an electrode tab 14, wherein the electrode tab 14 is attached to the electrode 12. The battery cell 30 can be, for example, a three-electrode pouch cell.

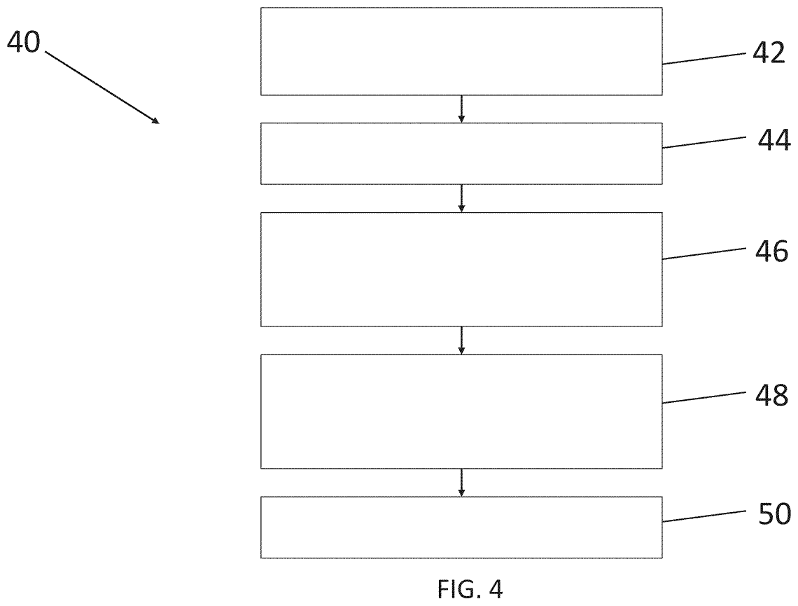

Now referring to FIG. 4, a method 40 of making an electrode assembly 10 can comprise step 42: roughing a surface of the center portion 16 of the electrode tab 14 to form the textured surface 18. Roughing the surface of the center portion 16 of the electrode tab 14 can comprise chemical etching, abrasion by an abrasive material, abrasion by ultrasonic waves, blasting with an abrasive material, or any combination(s) thereof. For example, the abrasive material can be any material suitable for roughing the surface, for example, sand paper.

The method 40 can further comprise step 44: cleaning the textured surface 18 of debris, for example, by air blowing. The method 40 can further comprise step 46: depositing an electrically conductive adhesive material to the textured surface 18 to form the adhesion layer 20. The method 40 can further comprise step 48: applying a masking material to a surface of the protrusion portion 22 of the electrode tab 14, the rounded portion 28 of the electrode tab 14, or any combination(s) thereof. In addition, the adhesive material and masking material can be smoothed and/or leveled, for example, by smearing and/or air blowing.

The method 40 can further comprise step 50: attaching the electrode tab 14 to the electrode 12 via the adhesion layer 20. In this way, the electrode tab 14 can avoid the use of mechanical fastening means when being attached to the electrode 12. For example, the electrode tab 14 can avoid the use of a bolt, screw, nail, or clamp fastening means. The rounded portion 28 can also protect the electrode from damage (e.g., cutting, tearing, or scrapping) because it lacks a sharp and/or pointed edge.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components (and encompasses “consist(s) of”, “consisting of”, “consist(s) essentially of” and “consisting essentially of”), but do not necessarily preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An electrode assembly, comprising:
an electrode; and
an electrode tab, wherein the electrode tab is attached to the electrode, wherein the electrode tab comprises:
a center portion, wherein the center portion comprises an attachment mechanism, wherein the electrode tab is attached to the electrode via the attachment mechanism;
a protrusion portion, wherein the protrusion portion extends from the center portion and protrudes beyond a perimeter of the electrode; and
a rounded portion, wherein the rounded portion extends from the center portion in a direction opposite the protrusion portion.

2. The electrode assembly of claim 1, wherein the attachment mechanism comprises a textured surface and an adhesion layer deposited on the textured surface, wherein the electrode tab is attached to the electrode via the adhesion layer.

3. The electrode assembly of claim 1, wherein the electrode is a reference electrode.

4. The electrode assembly of claim 3, wherein the reference electrode is flexible.

5. The electrode assembly of claim 1, wherein the electrode tab comprises metal, carbon, polymer, or any combination(s) thereof.

6. The electrode assembly of claim 5, wherein the electrode tab comprises gold, aluminum, carbon mesh, carbon cloth, a polymer plated with metal, or any combination(s) thereof.

7. The electrode assembly of claim 1, wherein the protrusion portion of the electrode tab is polygonal in shape, circular in shape, or any combination(s) thereof.

8. The electrode assembly of claim 7, wherein the protrusion portion of the electrode tab is “T” shaped.

9. The electrode assembly of claim 1, wherein the protrusion portion of the electrode tab protrudes beyond the perimeter of the electrode by a length of about 1 millimeter to about 5 millimeters.

10. The electrode assembly of claim 2, wherein the textured surface of the center portion has an average surface roughness value (Ra) of greater than or equal to about 2 micrometers.

11. The electrode assembly of claim 2, wherein the textured surface of the center portion has a developed surface area ratio of greater than or equal to about 40%.

12. The electrode assembly of claim 2, wherein the adhesion layer of the center portion comprises an electrically conductive adhesive material.

13. The electrode assembly of claim 12, wherein the electrically conductive adhesive material comprises an epoxy base, an acrylate base, a silicone base, or any combination(s) thereof, and a filler material.

14. The electrode assembly of claim 13, wherein the filler material comprises steel, gold, nickel, silver, copper, graphite, or any combination(s) thereof.

15. The electrode assembly of claim 1, wherein an electrical conductivity of the electrode tab is greater than or equal to about 2000 Siemens per centimeter.

16. The electrode assembly of claim 1, wherein masking material is deposited on a surface of the protrusion portion of the electrode tab, the rounded portion of the electrode tab, or any combination(s) thereof.

17. The electrode assembly of claim 1, wherein the electrode tab is free of bolts, screws, nails, clamps, or any combination(s) thereof.

18. A battery cell, comprising:
an electrode assembly, wherein the electrode assembly comprises an electrode and an electrode tab, wherein the electrode tab is attached to the electrode, and wherein the electrode tab comprises:
a center portion, wherein the center portion comprises a textured surface, and an adhesion layer deposited on the textured surface, wherein the electrode tab is attached to the electrode via the adhesion layer;
a protrusion portion, wherein the protrusion portion extends from the center portion and protrudes beyond a perimeter of the electrode; and
a rounded portion, wherein the rounded portion extends from the center portion in a direction opposite the protrusion portion,
wherein the battery cell is a three-electrode pouch cell.

19. A method of making an electrode assembly, wherein the electrode assembly comprises an electrode; and an electrode tab, wherein the electrode tab is attached to the electrode, wherein the electrode tab comprises: a center portion, wherein the center portion comprises a textured surface, and an adhesion layer deposited on the textured surface, wherein the electrode tab is attached to the electrode via the adhesion layer; a protrusion portion, wherein the protrusion portion extends from the center portion and protrudes beyond a perimeter of the electrode; and a rounded portion, wherein the rounded portion extends from the center portion in a direction opposite the protrusion portion; the method comprising:
roughing a surface of the center portion of the electrode tab to form the textured surface;
cleaning the textured surface of debris;
depositing an electrically conductive adhesive material to the textured surface to form the adhesion layer;
applying a masking material to a surface of the protrusion portion of the electrode tab, the rounded portion of the electrode tab, or any combination(s) thereof; and
attaching the electrode tab to the electrode via the adhesion layer.

20. The method of claim 19, wherein roughing the surface of the center portion of the tab comprises chemical etching, abrasion by an abrasive material, abrasion by ultrasonic waves, blasting with an abrasive material, or any combination(s) thereof.
